(19) United States
(12) Patent Application Publication
(10) Pub. No.: US 2010/0312400 A1
(43) Pub. Date: Dec. 9, 2010

(54) METHOD AND PUMP MANAGEMENT SYSTEM FOR OPTIMIZING THE ENERGY CONSUMPTION IN A RUNNING FLUID TRANSPORTING PIPE SYSTEM WITH PUMPS

(76) Inventor: Niels Peder Ledgard Steffensen, Tjele (DK)

Correspondence Address: WINSTON & STRAWN LLP;PATENT DEPARTMENT, 1700 K STREET, N.W., WASHINGTON, DC, 20006, US

(21) Appl. No.: 12/739,259

(22) PCT Filed: Oct. 23, 2008
(86) PCT No.: PCT/IB08/54377

§ 371 Date: Apr. 22, 2010

(30) Foreign Application Priority Data
Oct. 23, 2007 (DK) PA 2007 01523

(51) Int. Cl. G05D 7/06; F17D 3/00

(52) U.S. Cl. 700/282; 137/2

(57) ABSTRACT

A method and a pump management system for optimizing the energy consumption by operation of a fluid transporting pipe system having a number of pumps to move the fluid therethrough. During fluid transport from a starting point to an end point, one or more parameters can be measured, which alone or in combination represents at least an energy consumption for the operation of each pump or combinations of operation of pumps and the flow through the fluid transporting pipe system. On the basis of the established actual pump characteristics that are measured, system characteristic(s) and operation frequency/frequencies are chosen at which one or more of the pumps alone, alternating or at the same time, must pump in a period of time to achieve a given desired pumping speed through the pipe system or a given desired pump volume with the least possible total energy consumption.

The present invention relates to a method for optimizing the energy consumption in a running fluid transporting pipe system comprising a number of pumps for driving the fluid through the pipe system.

The focus has for long time been on environment and sustainability within fields such as drinking water and wastewater. Here the effort primarily has been directed towards avoiding waste of water and on reducing pollution. Both clearwater facilities and wastewater facilities use comprehensive pumping systems, which has a very large energy consumption, and thus not comply with the still increasing environmental requirements. This situation is not only limited to waterworks, but is valid for all fields where it is necessary to move and/or treat fluids in larger scale.

Electrical pumps used in above-mentioned facilities and in industry are responsible for a large part of the energy consumption in the industrial world, and therefore there has for long been a wish to be able to optimize the pump operation, especially from the pump manufactures. The manufactures measure the efficiency of the pumps at different rotational frequencies in a test system, and draw up a pump characteristics for the pump under standardized conditions, pressure, head, etc. The user employs the pump characteristics as basis for both the choice of pump type as well as for how the pump is to be utilized. From this pump characteristics is established a recommended optimal point of operation at which the pump is constantly run. However, a substantial problem is that there is very large difference on the conditions the pumps are tested under in a laboratory to define the pump characteristics and thus the pumps best point of operation at test and the conditions under which the pumps will actually be working. The standardized pump characteristics only provide an indication of the pump capacity without considerations of its energy consumption under test conditions. Focus is on an effective operation and not on an appropriate use and utilization of more pumps viewed from an energy consumption perspective. This means, that even if a user of a pump relates to the pump characteristics given by the manufacturer this does not mean that operation based on pump characteristics data and process parameters leads to the largest energy saving.

From U.S. Pat. No. 7,143,016 a control system for controlling a method, which comprises the use of one or more pumps is known. The method comprises to choose a point of operation within an allowed defined range around a process set point, which is established from either the pumps standard pump characteristics or from a wish to comply a user defined condition, such as filling a reservoir as fast as possible. The method is controlled on the basis of said chosen process set point, around which the entire operation is maintained. In case the operation of the system in which the pumps are running turns out not to run at the process set point, possibly considering a chosen acceptable smaller deviation, the control system can correct the operation back to the chosen process set point. This known control system prioritizes maintenance of high pump efficiency and maximal pump capacity no matter energy consumption, and its use can therefore require very high energy consumption and can thus be contributing to significant CO₂ production.

The primary task for both clean and wastewater facilities is to move water, and not when and how and how often this is done the best possible way seen from an energy and environment point of view. This means that the pumps often either are running on full power at a speed governed by the process parameters, or they stand still, which in itself can have an impact on the pumps and the entire pipe system as a whole due to the many and intensive water hammers, the system is exposed to when on/off operation is used.

Thus there exists a need to be able to use and control one or more pumps in fluid transporting systems in both large and small scale with the smallest possible energy consumption.

In a first aspect of the present invention is provided a method of the kind mentioned in the opening paragraph by means of which it is possible to ensure an environment friendly and energy efficient operation of pumps in fluid transporting pipe systems.

In a second aspect of the present invention is provided a method of the kind mentioned in the opening paragraph for controlling and optimizing the pump operation where the method is self-regulating and thus cost fewer man hours.

In a third aspect of the present invention is provided a method of the kind mentioned in the opening paragraph which reduces wear of the different parts in a pump system.

In a fourth aspect of the present invention is provided a method of the kind mentioned in the opening paragraph by means of which, with which it is easier than hitherto known to present energy data.

In a fifth aspect of the present invention is provided a method of the kind mentioned in the opening paragraph by means of which it is possible to pump crude water from one or more ground water wells to a reservoir or between several reservoirs with the least possible energy consumption.

In a sixth aspect of the present invention is provided a method of the kind mentioned in the opening paragraph by means of which it is possible to pump clean water to a distribution net.

In a seventh aspect of the present invention is provided a method of the kind mentioned in the opening paragraph by means of which it is possible to pump wastewater from one pumping station to another, to and from a purification plant or internally on a purification plant with the least possible energy consumption.

Within the scope of the present invention the term “energy consumption” is used synonymously about the power or the power consumption measured in kilowatt per quantum of pumped fluid, which at a given time of measurement can be recorded for the use of one or more pumps inserted in a pipe system, as well as about the used kilowatt hours per quantum pumped fluid through the entire pipe system where quantum for example is measured in volume or weight.

Within the scope of the present invention the term “operation of a pump” is used about the frequency at which the pump is run, i.e. including if the pump is on or off, at which frequency the pump runs and thereby if it is running at high or low energy consumption per pumped m³ fluid, and if there is high or low flow through the pump.

Within the scope of the present invention the term “a pump characteristics” is used about the performance curve under standard conditions for a pump inserted in a pump test station. The manufacturers typically dispatch the pump with a data sheet displaying curves of among other things head, efficiency, shaft power and NPSH-curves (Net Positive Suction Head). A pump is furthermore dispatched with a data sheet over “the pipe characteristics”, i.e. a data sheet which states how large a head the test pipe system demands as a function of the fluid flow. The pipe characteristics thus takes into account for example the specific drag of the fluids through the pipe system and the loss of kinetic energy when the pipe system is flown through. The pumps recommended point of operation is subsequently established at the intersection between the pump characteristics and the pipe characteristics. This recommended point of operation is however not necessarily the point of operation at which a number of pumps functions to drive a fluid through a pipe system, which is not standardized, at the smallest energy consumption in order to satisfy a given task or reach a given goal.

“The system efficiency” for a pump shall within the scope of the present invention be understood as a pump's energy consumption per pumped m³ fluid in the pipe system.

When the expression “actual pump characteristics” is used in the present application, an energy characteristics established for pumping and flow through one or more components of a fluid transporting pipe system under different conditions and for determined goals, is understood. Preferably, actual system characteristics are measured for all sorts of configurations of the components and conditions of the system, from measurements of flow and energy consumption during the fluid transport.

Within the scope of the present invention the method can be used at one single or more selected pumps in a given pipe system. This means a pipe system can within the scope of the invention comprise both regulated and non-regulated pumps depending on which configuration, at a given situation, task or purpose, the best possible way can be used in order that the operation can be performed with the immediate least possible energy consumption taking in consideration that a pumping task must be solved. The actual pump characteristics is maintain as long as it is possible, until the possibility of maintaining the operation only upon a energy conservation aspect is put aside by other process parameters or security parameters, as for example, over flow, too low fluid level, etc.

The novel and unique according to the invention whereby this is achieved consist in that the method comprises the steps
a. for a fluid transport through the pipe system from a starting point, from where the fluid is pumped, to an end point whereto the fluid is pumped, measuring one or more parameters, which alone or in combination represents at least an energy consumption for the operation of each pump or combinations of operation of pumps and the flow through the fluid transporting pipe system,
b. on the basis of the measured parameters establishing actual systems characteristics for the operation of each pumps or combinations of pumps for the flow through the pipe system from the starting point to the endpoint, and
c. on the basis of the established actual pump characteristics to choose that and/or those system characteristic(s) and operation frequency/frequencies at which one or more of the pumps alone, alternating or at the same time must pump in a period of time to achieve a given desired pumping speed through the pipe system and/or a given desired pump volume at the least possible total energy consumption.

As mentioned above it has become apparent that the pump characteristics, which are given by the pump manufacturer, not reflect a pumps actual system characteristic when the pump is inserted in a fluid transporting pipe system. However, on the basis of the energy consumption measured for the one or more pumps and the fluid flow measured through the pipe system, a system characteristics can be drawn up by means of which it is possible to describe and as a result optimize the pump operation in a given pipe system or in any other fluid transporting configuration comprising pumps and pipes.

An overall or more separate actual system characteristics for one or more parts of a fluid transporting system can thus advantageously be determined by measuring and monitoring different operational parameters for the system while it is at use. The one or more actual system characteristics gives better possibility than hitherto known to optimizing the energy consumption for operation of pumps in fluid transporting pipe systems, because considerations is taken to how the pump or the pumps actually in fact is/are working in a given pump configuration with pipes and other components such as for example open, closed or partly opened valves, reservoirs, different heads in the pipe systems, groundwater level or level in reservoir, pipe bendings, materials, demands for a necessary pumping volume or pumping time interval etc. A fluid transporting system having pumps can this way be utilized in a manner so that as little energy as possible is used at a given task at a given time.

By using the actual pump characteristics for operation of the pipe system it is thus possible to weigh which and how one single or more pumps in a given pipe system shall be utilized in operation for solving a given task at the most energy efficient way based on measurements on the components of the pipe system, including a.o. but not limited to, pipes and one or more pumps, as well as levels of ground water or reservoir. A given task includes within the scope of the present invention for example to fill or empty a reservoir at a given level, at a given deadline or at a given final volume, to keep a reservoir completely or partly filled or emptied, to maintain a wanted pump pressure, etc.

In a preferred embodiment of the method according to the present invention one or more of the steps a, b, and/or c can advantageously be repeated in order to re-regulate the combination of the operation of the pumps so that the least possible energy is used to move a quantum of fluid over a given period of time and/or to reach or maintain a given pump volume or final volume. One or more pumps can e.g. work continuously over longer periods of time at frequencies which requires a low energy consumption per pumped m³ fluid instead of the normal on/off operation, or process parameter determined flow speed which for one part not is expedient from a energy saving point of view, but also puts a lot of wear on e.g. the pumps in the pipe system in that one pump or more pumps contributes as a part of the whole pipe system where through the fluid must be transported.

The method can be used with any number of pumps in the pipe system, but the method typically finds its most advantageous use when the number of pumps is larger than or equal to 2, in that the more pumps available in the system, the more complex the system becomes and the larger the degrees of freedom for modification of the utilization of the pumps and redirect the operation to use the most energy efficient pump(s) and pip(s) for a given task. One, two or arbitrary number of pumps running alone, alternating, more at the same time, or all pumps at the same time are thus comprised within the scope of the present invention in that it is strived for reaching the most energy saving utilization of the pumps for solving a given task.

In a preferred embodiment for the method according to the invention the actual system characteristics can be calculated on the basis of at least a measured energy consumption for the pump and a measured fluid flow through the pipe system.

Preferably the steps a-d are performed at fixed equal or different time intervals. Alternatively all the steps a-d are performed or repeated upon an evaluation of whether a given goal for pumped fluid through the pipe system is achieved at a given time or within a given period of time.

Advantageously the operation of the pumps can be controlled by at least one frequency converter regulating the frequency of the pump. The regulation can be carried out via the motor of the pump. The operation of the pumps can be regulated on the basis of at least one of the parameters selected from the group including energy consumption and flow. I.e. it is possible to control the pump operation so that it in general is the most energy-wise operation, which is achieved, but if necessary that at any time it is possible to enhance the flow, e.g. in case of a sudden peak load of the pipe system. To meet such a peak load it is possible to tune up the pump frequency in a manner where it is still near the optimal point of operation, but it is also possible to maximize the fluid flow in the system completely without any energy considerations at all if necessary.

The method can advantageously comprise to process the measured, and optionally regularly monitored parameters, including but not limited to flow and/or energy parameters by means of a software program, which is run on a computer or PLC, in order to determine the actual system characteristic(s) for the pumps, the pump configurations and the pipe system during operation, and to generate a set of updated regulation data for regulating the at least one frequency converter in order to reduce the energy consumption of the pumps to the least possible to achieve a given goal for fluid pumped through the pipe system at a given time or a given time interval.

Hereby a flexible and simple regulation of the energy consumption of the pumps is achieved while the fluid flow through the system for example can be kept constant. The software program can e.g. regulate down the operation of one energy demanding pump and regulate up the operation of a less energy demanding pump whereby the overall energy consumption is reduced in a simple way.

This regulation can particularly easily take place if the method is self-regulating and self-optimizing so that no extra resources are demanded to ensure an energy-optimized operation of the one or more pumps.

The system efficiency of the at least one pump can continuously be calculated and monitored, which ensures a constant adaptation to the actual conditions of the pipe system. For this purpose the method can include that above-mentioned steps are repeated at regular or non-regular intervals.

To allow current and easy access to informations about the operation of the at least one pump, the system efficiency of the at least one pump can preferably be read, e.g. manually on a visual display, optionally indicating the efficiency by means of color codes.

When the method further more comprises to calculate data for reduction of energy consumption and reduction of CO₂, and optionally to present the calculated data on the visual display or on a secondary display, it can easily be monitored if the company, e.g. the waterworks, reaches otherwise appointed goals and meets environmental requirements, and it can be a general motivator to continue and enhance the environmental achievement.

The invention further relates to a pump management system for optimizing the energy consumption when operating a fluid transporting pipe system including a number of pumps for driving the fluid through the pipe system.

The pump management system according to the present invention comprises
means for, for a fluid transport through the pipe system from a starting point, from where the fluid is pumped, to an end point to where the fluid is pumped, to measure one or more parameters, which alone or in combination represents at least an energy consumption and flow for the operation of each pump or combinations of operation of pumps and the flow through the fluid transporting pipe system,
means for monitoring the parameters,
means for, on the basis of the monitored parameters, to calculate actual system characteristics for the operation of each pump or combinations of pumps for the flow through the pipe system from the starting point to the end point, and for, on the basis of the determined actual pump characteristics, to choose that system characteristic and operation frequency at which one or more of the pumps alone, alternating or simultaneously must be active in a period of time in order to achieve a given wanted pumping speed through the pipe system and/or a given wanted pumping volume with the least possible total energy consumption.

The use of this novel and unique pump management system makes it possible to control and regulate an overall, given existing or new pipe system with a number of pumps taking in consideration the energy consumption when choosing different pumps and pumping routes in the pipe system, as well as it is possible to regulate up and down one or more of the operation frequency of the pumps on the basis of energy measurements and calculations, such that the pipe system as a whole always can be run with the lowest possible energy consumption to achieve a wanted goal or solve a given task, as mentioned above for the method.

Advantageously the pipe monitoring system comprises at least one frequency converter for regulating the operation frequency of the pumps in the fluid transporting pipe system.

The means for calculating actual system characteristics on the basis of the monitored parameters is expediently a software program running on a computer or PLC, which can allow for online data calculation and immediate update of data and choice of energy optimal system characteristics or combinations of system characteristics, so that the time delay between the registration of that the operation of the pipe system is not energy optimal and the regulation of the operation is executed, can be made as short as possible. The use of a software program therefore contributes this way to additionally saving of energy and reducing of wear and tear on pumps and pipes. The use of the pump managing system with a software program allows for the resolution of a diversity of pumping tasks as energy saving as possible, but can also fast and effectively change the order of priorities or regulate one or more pumps or pumping routes in the pipe system in case external conditions, demands or requirements demands this, as mentioned going through the method above.

Regular measurements of the parameters in real time and processing of the parameters in the software program enable online monitoring of the operation of the pipe and pump system, and possibility of tuning the pipe and pump system by immediately reacting to fluctuations or shifts in the energy consumption.

The pump management system has especially been proven, effective for saving energy during operation of a fluid transporting pipe system with pumps, when the fluid is chosen from the group consisting of crude water from a ground water well, clear water from a waterworks, or an other natural reservoir, cleaned wastewater from or to a purification plant or a pumping station. This will be apparent from the following examples and curves.

wells for alone or in combination to pump water to or from a reservoir using the least possible energy consumption.

The method is described in greater detail below with reference to the drawings, where

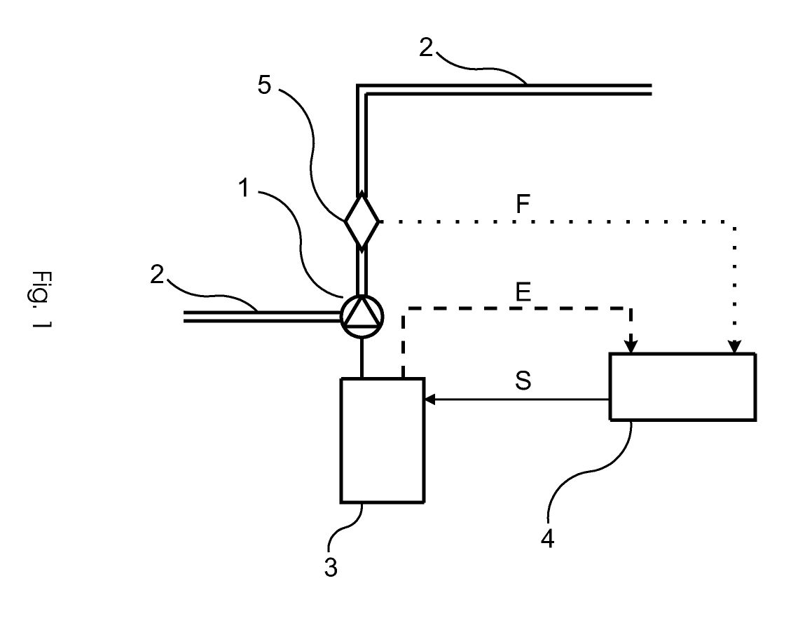

FIG. 1 shows a simple flow diagram of a fluid transporting pipe system with a single pump only,

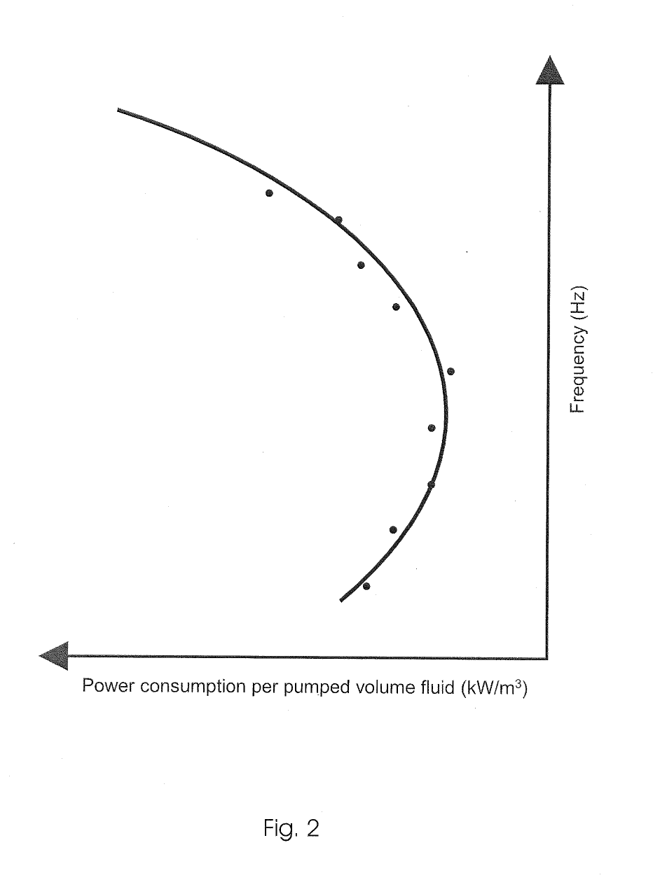

FIG. 2 shows an example of a measured system characteristics,

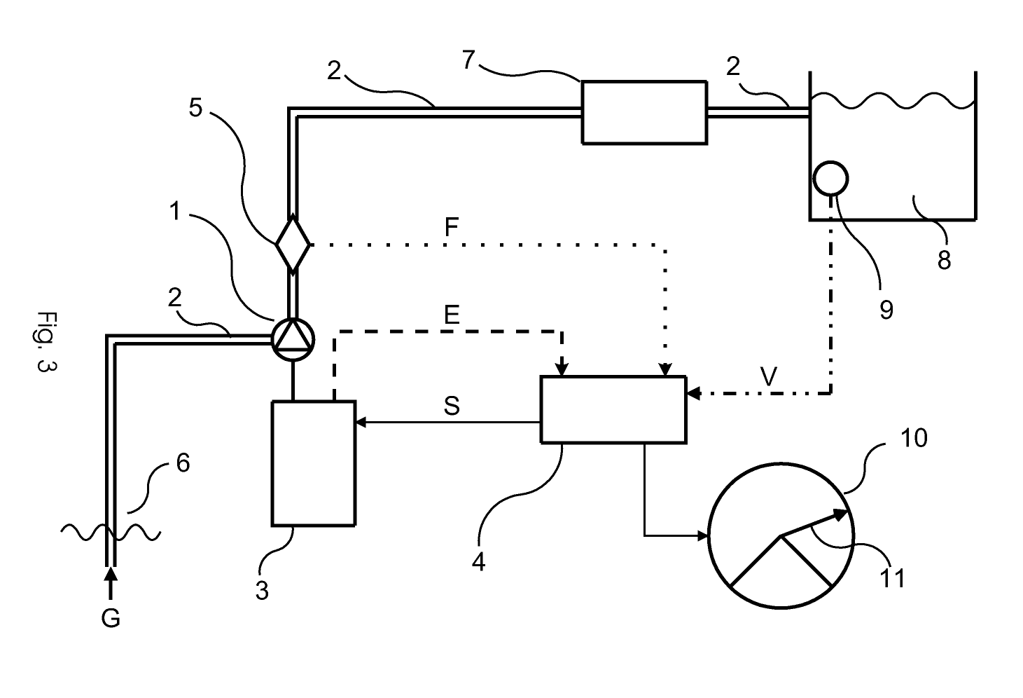

FIG. 3 show a simple flow diagram for a crude water plant with a single pump only, pumping the water to a clear water reservoir,

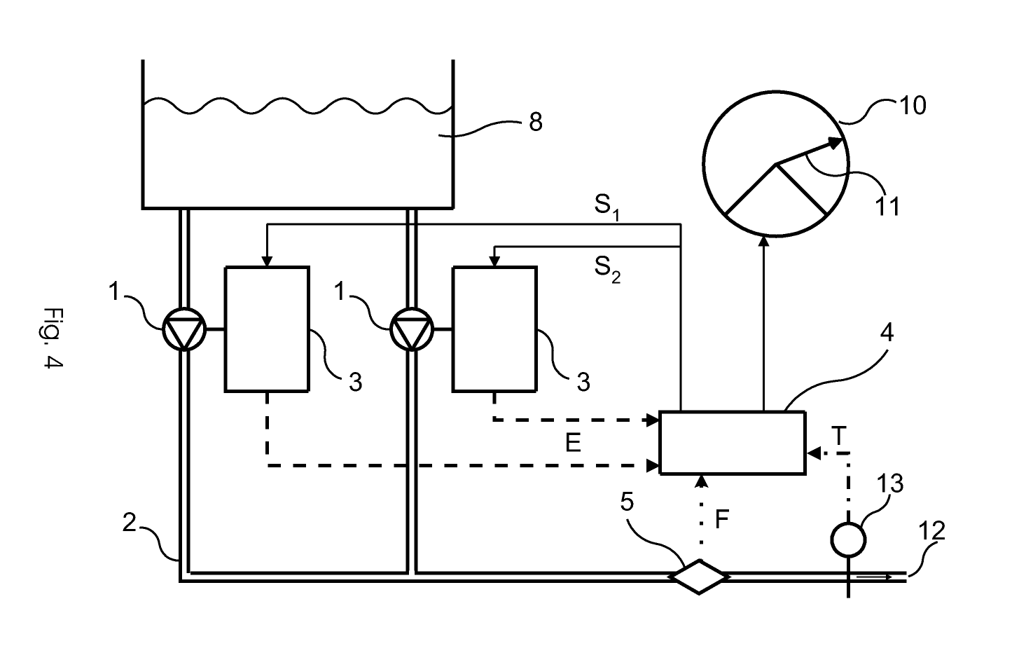

FIG. 4 shows a simple flow diagram for a fluid transporting clear water plant with two pumps, pumping clear water to a distribution net,

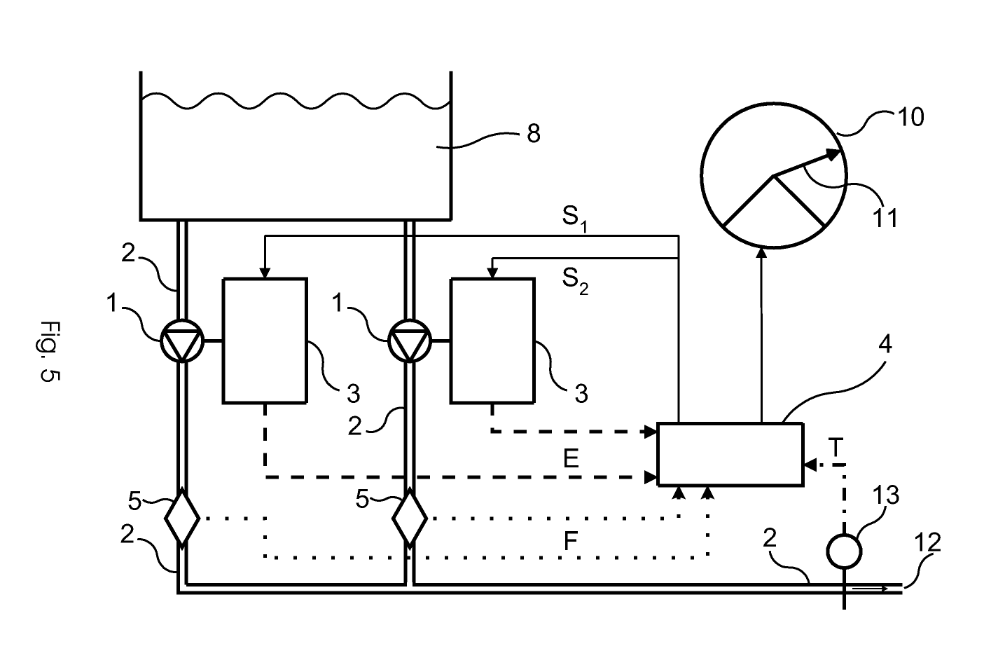

FIG. 5 shows a simple flow diagram for a fluid transporting pipe system with two pumps having each their flow detector,

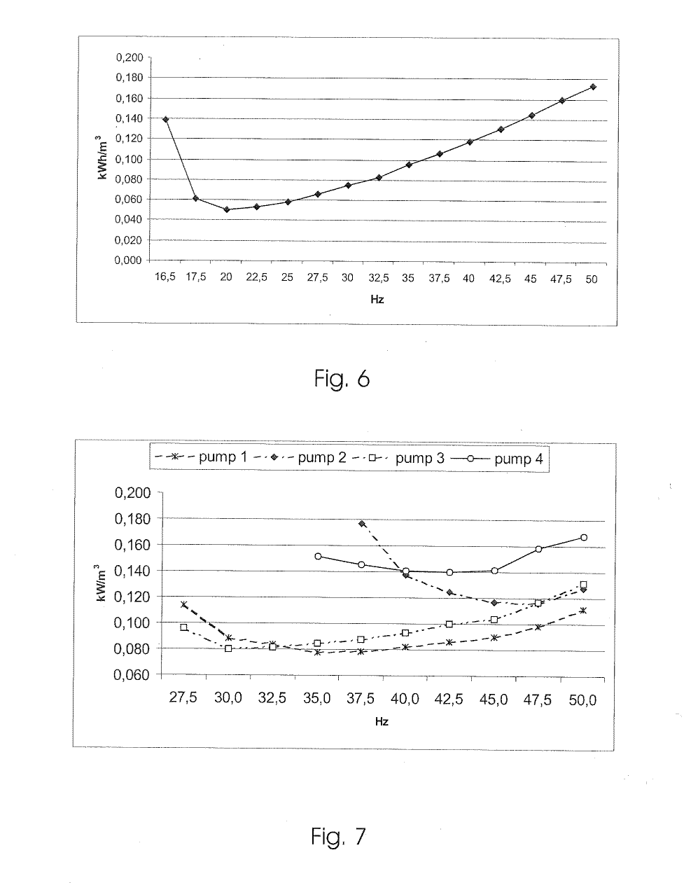

FIG. 6 shows an example of an actual system characteristics for a pipe system with one pump,

FIG. 7 shows another example with four actual system characteristics, one for each of four mutually independent pumps, which can be running alone or at the same time, and

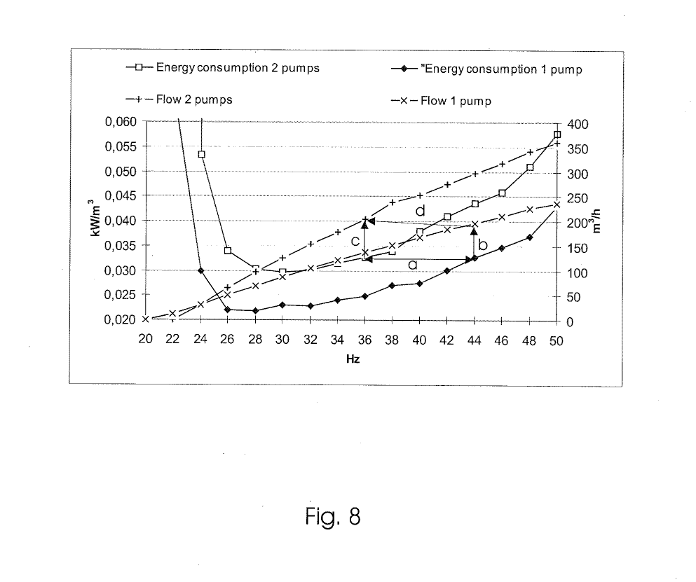

FIG. 8 shows flow curves together with actual system characteristics for a pipe system having one and two pumps, respectively.

The system shown in FIG. 1 contains a pump 1 inserted in a pipe system, which generally is designated by the reference number 2.

The operation of the pump 2 is regulated by a frequency converter 3 regulated by means of a software program (not shown) running on a computer 4. Upstream of the pump 1 is mounted a flow detector 5. Within the scope of the present invention more flow detectors can be used, including flow detector downstream of the pump 1. The flow detector measures m³ fluid passing through the pipe system per time unit, e.g. per hour. The measured flow data is recorded, registered and transmitted at input data to the computer 4, which is processing them to produce output data for use to regulate the pump 1 to reduce the energy consumption of this pumps taking in consideration the wanted operation level. The frequency converter 3 is delivering information about consumed energy, kilowatt (kW), at a given pump frequency, Hertz (Hz). These data, kW and Hz, are registered and transmitted on to for example the computer 4. From the measured data, flow, frequency, effect and energy an actual system characteristics for the pump in the specific pipe system can be created.

An example of such an actual pump characteristics is shown in FIG. 2.

FIG. 3 shows an example of a flow diagram of a crude water plant. Since the components, which are part of this plant, corresponds to the fluidly interconnected, electrically interconnected and mechanically interconnected components, respectively, which were used in the simple plant shown in FIG. 1, same reference numerals are used for like parts.

In this example the pump 1 is gathering groundwater from a natural reservoir 6. The pump 1 is regulated by means of a frequency converter 3, which are controlled by input, as indicated by the arrow S, from a software program running on a PLC 4. Upstream of the pump a flow detector 5 is mounted. Data from the flow detector 5, as indicated by the arrow F, and data from the frequency converter 3, as indicated by the arrow E, is processed by the software program to calculate the total energy consumption at a given flow, i.e. the total kWh/m³. These kWh/m³ data are registered and transmitted to the computer 4. Groundwater is, as indicated by the arrow G, pumped through a filter 7 and into a water tank 8. The water tank 8 has a detector 9 registering the amount of water in the tank 8. This information is forwarded to the computer 4.

The actual system characteristics is calculated by the computer program, and since this actual pump characteristics now is known, it is possible, by monitoring and registering the frequency of the pump, to gain information about how close to the optimal operation frequency range the pump is operated at a given time. Such information can be visualized by e.g. an energy speedometer 10, which for example can be divided into three color fields, a red, a yellow and a green (not shown). Alternatively or inclusive of the energy speedometer can display a scale of numbers. If the pump 1 is running acceptable energy-wise the speedometer needle 11 is in the green field, if the operation is average the speedometer needle is in the yellow field, and if the operation is far from optimal the speedometer needle 11 is in the red field. Equivalent indication can be achieved by a scale of numbers.

If the detector 9 is registering that the water tank is not being filled fast enough, it is possible for the computer 4 to regulate the operation of the pump 1 so that the fluid flow in the pipe system is regulated up. It is a possibility to regulate up the flow to a degree where the pump still is operated close to the optimal operation set point, i.e. the most energy saving pump frequency, but it is also possible to drive the pump for shorter or longer intervals all up to its maximal frequency and thus achieve maximal fluid flow through the pipe system without consideration for the energy consumption. As soon as the meter 9 is registering, as indicated by the arrow V, that the water level in the tank 8 is suitable, the pump operation is again adjusted via input from the computer 4 to the frequency converter 5 to as close to optimal operation as possible when taking into consideration, among other things, the water level in the water tank 8.

In the crude water plant shown in FIG. 3 only one pump 1 is used, but the method can easily work with a arbitrary number of pumps.

FIG. 4 shows an example of a fluid transporting clear water plant with two pumps 1 connected in parallel. A single flow detector 5, which is situated in a chosen location in the pipe system 2, preferably a location without turbulence, serves for supplying flow data to the PLC 4. Within the scope of the present invention the flow detector can be located other places than the one shown in FIG. 4. FIG. 4 is thus only showing an exemplary embodiment for the placement of a flow detector in a plant having two pumps 1.

In the example shown in FIG. 4 of a pipe system 2, water is pumped from a water tank 8 out to for example the consumers in a city 12. The water is pumped by use of two pumps 1, regulated by each their frequency converter 3. The frequency converter 3 is controlled by input, as shown by the arrows S₁ and S₂, from a software program running on a computer/PLC 4. Upstream of the pipe system 2 is mounted a flow detector 5 measuring the fluid flow pumped by all relevant pumps 1, here two, inserted in the converters 3 and a computer or PLC 4. Data from the flow detector 5 is also registered and transmitted to the computer frequency converter 3 is processed by a software program to calculate the total energy consumption at a given flow, i.e. the total kWh/m³. In the example schematized in FIG. 4 a further pressure detector 13 is located in an appropriate place towards the end of the pipe system 2. This pressure detector 13 transmits information, as indicated by the arrow T, to the software in for example the computer 4, whether there is a suitable water pressure to the consumer 12. In case the pressure measured by the pressure detector 13 not is sufficient the frequency of, and thus the flow from, at least one of the pumps 1, is regulate up in order for the desired water pressure to be achieved. The regulation of the pumps 1 is controlled by the computer/PLC 4 via the frequency converter 3.

In an alternative embodiment for the one shown in FIG. 4 the water can also be pumped directly from the ground water well to the distribution net.

The plant shown in FIG. 5 corresponds to the one described for FIG. 4 and differs only in that every pump has a separate flow detector.

Combinations of the above-mentioned use of pumps, flow detectors and frequency converters are intended within the scope of the present invention. For example the fluid flow through each single pump can be measured after each pump, and the total fluid flow can be measured separately at a location later in the pipe system.

It is thus possible, as in the example illustrated in FIG. 4, to create a total system characteristics for the pumps in the pipe system, but it is also possible, as shown schematically in FIG. 5, to create individual actual system characteristics for each of the pumps or system characteristics for combinations of pumps in the pipe system. Furthermore it is possible to choose to create individual, actual pump characteristics for each of the pumps and at the same time create total, actual system characteristics for the entire pipe system or for parts of the pipe system.

It is also possible to create a continuous measurement of the fluid flow in the system. Together with data from the frequency converter such a continuous measurement renders it possible to get information about the plants consumed kW/m³ at a given frequency at any given time. If this value increases to an expected value compared to the actual system characteristics, it can for example be an indication that the pump is worn, that for example calcareous deposits are present in the pipe system, or that other types of wear and tear are present. Hereby a visualization of the operation of the pumps can prevent unnecessary stop downs or large reconditioning which could have been prevented by an early service check of for example pump or pipe system. Alternatively, relevant operational data can also be acquired from for example direct access to the operational data files produced by relevant software, or any other given way, which enables the user to acquire relevant information about the operation of the system.

A flow detector is however expensive why many do not want to invest in one such. If this is the case, a thorough flow/energy analysis is made at the implementation of the optimization system, to establish the pipe systems actual pump and system characteristics, which thus establish the basis for optimization of the operation together with the regular monitoring of the pump frequency and the energy consumption. A sudden change in the energy consumption at a given frequency will indicate an error on or in the pipe system/pump.

When the actual system characteristic is known, it is possible for example via the computer 4 and the frequency converter 3 to ensure at all time that the pump is being operated as close to the most energy-wise frequency as wanted and possible. Whereas in the example of FIG. 3. and FIG. 4 one or more permanent flow detectors are found, the flow detector can in this situation be removed after the actual system characteristics is found. The actual system characteristics for the pump/pipe system does not change significantly as long as the pump/pipe system is left unchanged, for example over time due to wear and deposits. If for example a new pump is installed, or if the piping is changed, a new actual system characteristics must be created for the new pump/pipe system. In this case it is also necessary to keep an eye on wear of the pumps etc. by use of traditional means. From the actual system characteristics, FIG. 2, it is possible to choose an advantageous frequency or an advantageous frequency interval, where it will cost the least possible energy to move the wanted m³ of fluid, possibly within a given time interval.

FIG. 6 shows an example of an actual system characteristics for a pipe system having one single pump, where the actual system characteristics show energy consumption (kW/m³) as a function of the frequency (Hz) of the pump in a pipe system leading fluid from a first reservoir to a second reservoir. The curve has its minimum at 20 Hz, which means that at this frequency the most m³ of fluid is pumped through the pipe system per used kWh. In practice it can be useful to have an optimal interval of operation instead of an optimal point of operation, and in the shown case an optimal interval of operation is ranging from about 17.5 Hz to about 25 Hz.

At on/off operation, which often is traditionally used in cases as the present, the pump is running at maximal frequency as long as there is water which need to be moved. The pump is shut off when the wanted water level is reached in the first and/or the second reservoir. It is clearly seen that operation at maximal frequency, i.e. 50 Hz, is far from being advantageous, and that running at a too low frequency less than about 16 Hz can have the same consequences. If the actual system characteristics is not known the use of for example a PID regulator will possibly result in a too high energy consumption, just at a too low frequency.

The pumping from the first reservoir can alternatively be controlled by a process parameter, e.g. in the form of a distance x cm from the bottom of the first reservoir. The controlling functions in such a manner that when the first reservoir is should be emptied the pump is being made to run at maximal frequency until the water level is reduced to the distance x, following which the frequency of the pump is lowered to a minimum, e.g. by a PID regulator. In this case it can be demonstrated that the energy consumption at running at both the maximal frequency and the lowest frequency is resulting in an energy consumption far above the energy consumption in the optimal interval of operation from about 17.5 Hz to about 25 Hz, preferably 20 Hz.

This means that if the pump used in FIG. 6 is running from the shown actual system characteristics instead of by on/off operation or is controlled by a process parameter, large energy savings, and as a result e.g. CO₂, can be retrieved on the day to day operation of the system. If the pump is controlled based on a process set point instead it will be arbitrary where on the system characteristics the pump will be running.

FIG. 7 shows four actual pump characteristics for four mutually independent groundwater pumps. The groundwater pumps can run separate or at the same time and fulfills the task of filling a reservoir with water from four independent groundwater wells in a field.

A first curve, marked by -*-, shows the actual system characteristics for groundwater pump 1, the relationship between energy consumption per pumped m³ (kW/m³) and the frequency of the groundwater pump in Hz.

A second curve marked with -♦- shows the same for groundwater pump 2.

A third curve marked with -□- shows the same for groundwater pump 3.

A fourth and last curve marked with -∘- shows the same for pump 4.

On the basis of the demonstrated actual system characteristics, the first pump being activated will be pump 1, since this curve has the lowest minimum. Pump 1 is made to run at a frequency between about 35 and about 37.5 Hz, as it is in this interval the minimum of the curve is found. If it becomes necessary to pump a larger amount of groundwater than pump 1 can pump without increasing the frequency of pump 1 to a level where the energy consumption is inappropriate, pump 3 is started at a frequency of about 30 Hz. In situations where pump 1 and pump 3 cannot deliver the required groundwater flow, pump 1 and pump 3 are regulated to respectively about 50 and about 47-50 Hz simultaneously. At additional need pump 2 is started at a frequency of about 47.5 Hz. This frequency is increased at additional need to about 50 Hz before pump 4 initially is put into service, if additional pump capacity is required once more. It is shown, that the curve for pump 4 is quite flat in the interval from about 37.5 to about 45 Hz, and that pump 4 therefore can run in a convenient interval around about 42.5 Hz and be increased to about 50 Hz for maximum capacity.

If the groundwater flow in periods do not live up to a required process parameter, e.g. that the groundwater flow at a peak load is insufficient, the energy optimization can temporary, manually or automatically, be disregarded an reintroduced, when the circumstances allow it. The pumps are brought to run with energy optimization again, i.e. with the pump management system and the method according to the invention, when online monitoring indicates, that the actual system characteristics of the pumps individually or in some combination can be utilized again to supply a sufficient groundwater flow to the reservoir under the best energy optimized conditions.

FIG. 8 includes four curves, respectively showing flow measured in m³/h and energy consumption measured in kW/m³ as function of the frequency of the pump at operation with one pump and two pumps, respectively. I.e. it regards flow curves as well as actual system characteristics for a system with one and two pumps respectively.

A first curve marked with -□- shows energy consumption for simultaneous operation of two pumps measured in kW/m as function of the frequency of the pumps measured in Hz, i.e. the first curve shows the actual system characteristics of a pipe system with two active pumps. A second curve marked with shows the flow for the simultaneous operation of two pumps measured in m³/h as function of the frequency of the pumps measured in Hz. A third curve marked with -♦- shows the energy consumption for the operation of one pump measured in kW/m³ as function of the frequency of the pump measured in Hz, i.e. the third curve shows the actual system characteristics of a pipe system with only one active pump. A fourth and last curve marked with -X- shows the flow for the operation of one pump measured in m³/h as function of the frequency of the pump measured in Hz.

By means of the following simple graphical consideration it can be found from the curves, if it is the most efficient to run with one or two pumps:

Horizontal arrow a is drawn such as to connect the two energy consumption curves -X- and -♦- at points with same energy consumption kW/m³. Where horizontal arrow a meets the energy consumption curves, perpendicular arrows b and c from the energy consumption curves -X- and -♦- is drawn up to the belonging flow curves -+- and -□-. More precisely this is done such that arrow b connects the third and fourth curve, i.e. the curves showing the results of measuring with one pump, and arrow c connects first and second curve, i.e. the two curves, visualizing the measurements carried out with two simultaneously working pumps. Then arrow d is drawn such that it connects the points where arrow b and c meet the flow curves. The direction of arrow d is from arrow b against arrow c. If arrow d points upwards most water will be pumped with two pumps at same energy consumption. The same applies, that if arrow d points downwards most water will be pumped with one pump at the same energy consumption.

In the above-mentioned case it is demonstrated, that it is most efficient pumping with one pump up to about 44 Hz, after which a shift to two pumps at about 36 Hz ought to be made.

When the efficiency of the at least one pump is known before optimization of the system, it can continuously be calculated, how many kilowatt hours that are saved by implementation of this new method for optimization of the operation of pumps, and thus the optimization of the consumption of energy of the pumps. By these means it is possible continuously to get information, among other things about environmental gains, such as lowered CO₂ emission and reduced energy consumption.

It is shown, that by means of the method and pump management system according to the present invention it is often possible in a simple way to reduce the energy consumption in a fluid transporting pipe system with motor driven pumps with up to 30-40%, once in a while more or less. Examples of in all up to 50% are not unusual.

### EXAMPLE

Comparative data for filling a clear water reservoir with and without energy optimization.

| | | | | Energy | |
|---|---|---|---|---|---|
| | | | | consumption by | Energy savings for |
| | | Energy | | energy-prioritized | chosen pump |
| | Energy | consumption | Energy-savings | operation | configuration with |
| | consumption | at use of | by use of actual | considering | energy optimization |
| | at on/off | actual system | system | demand to filling | and demand to |
| Well | operation | characteristics | characteristics | rate | filling rate |
| number | (kW/m³) | (kW/m³) | (%) | (kW/m³) | (%) |
| B1 | 0.138 | 0.107 | 22.7% | 0.122 | 11.5% |
| B2 | 0.154 | 0.124 | 19.5% | 0.137 | 10.9% |
| B3 | 0.113 | 0.076 | 32.8% | 0.095 | 16.0% |
| B4 | 0.156 | 0.135 | 13.6% | 0.143 | 8.8% |
| B5 | 0.168 | 0.098 | 41.6% | 0.117 | 30.3% |
| B6 | 0.139 | 0.116 | 16.7% | 0.139 | 0.0% |
| B7 | 0.105 | 0.079 | 25.1% | 0.088 | 16.8% |
| B8 | 0.168 | 0.090 | 46.0% | 0.154 | 8.0% |
| B9 | 0.132 | 0.087 | 34.0% | 0.119 | 10.0% |
| B10 | 0.090 | 0.073 | 18.5% | 0.081 | 9.6% |
| Average: | | | 27.1% | | 12.2% |

The table shows data from ten different wells provided with pumps, which all are used to fill a clear water reservoir.
First column indicates the number of the well.
Second column indicates the energy consumption for each one of the ten pumps per pumped m³ (kW/m³) at traditional of/off operation.
Third column indicates the optimal energy consumption for each one of the ten pumps per pumped m³ (kW/m³) at energy optimized run after the actual system characteristics for each one of the ten pumps.
Fourth column indicates in % the saving of energy at optimal run of the actual system characteristics for each one of the ten pumps in relation to traditional on/off operation. Very large energy savings have been demonstrated if the pumps are run at the frequency giving the lowest kW/m³ value. The highest saving percentage of 46.0% is noted at well B8, and an average saving for the ten pumps of a total of 27.1% is noted.

However in the present example the achieved flow at optimal energy consumption is not sufficient to satisfy the relevant process parameter, which in this case is the filling speed of the clear water reservoir. Therefore the operation of the pump is adjusted towards an increased flow, while the actual system characteristics of the system are still considered. I.e. that even if the operational frequency of the pumps are adjusted away from the energy optimal point, it is still possible, on the basis of the actual system characteristics, to choose a considerable energy optimized configuration of the system, where the pumps all together are pumping the required quantity of water with a considerable smaller energy consumption than by traditional operation.
Fifth column indicates thus optimized energy consumption for each one of the ten pumps per pumped m³ (kW/m³) taking in consideration the process parameter requirement, which is that the reservoir has to be filled at a certain speed.
Sixth column indicates in % the energy savings of the combined run, in which the process parameter requirement is taken in consideration when the pumps are running with energy optimized pump management after the actual system characteristics for the ten pumps, in relation to the energy consumption at traditional of/off operation.

Thus it is shown, that even in a case, where the energy optimal operational point do not deliver enough water supply to the reservoir, there is a considerable saving to obtain by adjusting the operation of each one of the pumps based on knowledge of the actual system characteristics.

Thus the method according to the present invention operates, unlike the prior art, not at a process set point at the decisive moment, but with a process set point over time. With a continuous on-line monitoring of the actual system characteristics and readjustment on the basis of these, a given pump configuration in a given pipe system configuration can be adjusted to run as energy optimized as possible. Even if a special process requirement has to be fulfilled, it is possible to run periodically completely energy optimized, or over a longer period to operate partially energy optimized. In all cases the use of the method and the pump management system according to the present invention in new, and already existing equipments results in larger energy savings than hitherto possible.

1-15. (canceled)

16. A self-regulating method of optimizing the energy consumption per quantum pumped fluid by operation of a fluid transporting pipe system comprising a number (n) of pumps to move the fluid through the pipe system, which method comprises the steps of:
measuring one or more parameters for fluid transport through the pipe system from a starting point, from where the fluid is pumped, to an end point whereto the fluid is pumped, wherein the parameter(s) alone or in combination represent(s) at least an energy consumption per quantum pumped fluid for the operation of each pump or for combinations of operation of multiple pumps and the flow through the fluid transporting pipe system;
determining, on the basis of the measured parameters, actual system characteristics for each pump's or combinations of pumps' operation when said pump(s) provide(s) for flow through the pipe system from starting point (A) to end point (B);
selecting, on the basis of the established actual pump characteristics, that or those system characteristic(s) or operation frequency/frequencies at which one or more of the pumps alone, alternating or at the same time, must pump in a period of time to achieve a given desired pumping speed through the pipe system or to achieve a given desired pump volume with the least possible total energy consumption per quantum pumped fluid, and
repeating one or more of the measuring, determining or selecting steps in order to re-regulate the combination of the operation of the pump(s);
wherein the operation frequency of the pump(s) is regulated by at least one frequency converter.

17. The method according to claim 16, wherein the system characteristic(s) or operation frequency/frequencies of the pump(s) are selected to achieve both a given desired pumping speed through the pipe system and a given desired pump volume with the least possible total energy consumption per quantum pumped fluid

18. The method according to claim 16, wherein the number (n) of pumps in the pipe system is greater than or equal to 2.

19. The method according to claim 16, wherein at least one of the measuring, determining, selecting or repeating steps is performed with fixed equal or different time intervals.

20. The method according to claim 16, wherein at least one of the measuring, determining, selecting or repeating steps is performed upon an evaluation of whether a given goal for pumped fluid through the pipe system is achieved at a given time or a given range of time.

21. The method according to claim 16, which further comprises processing the measured parameters by a software program running on a computer or PLC in order to establish the actual system characteristics for the pump(s), the pump configurations or the pipe system during operation.

22. The method according to claim 21, wherein the processing generates a set of updated regulation data for regulating the at least one frequency converter in order to reduce the energy consumption per quantum pumped fluid of the pump(s) to the least possible to achieve a given goal for pumped fluid through the pipe system at a given time or a given time interval.

23. The method according to claim 22, which further comprises regularly monitoring the measured parameters to view changes which suggest applying the processing to generate the updated regulation data.

24. The method according to claim 16, which further comprises showing the efficiency of the pump(s) on a visual display and optionally a color visual display.

25. The method according to claim 24, which further comprises calculating data for the reduction in energy consumption per quantum pumped fluid and reduction in CO₂.

26. The method according to claim 25, which further comprises presenting the calculated data on the visual display or on a secondary display.

27. The method according to claim 16, wherein the fluid is chosen from the group consisting of crude water from ground water well, clear water from reservoir to reservoir, clear water from waterworks, or another natural reservoir, cleaned or uncleaned wastewater from or to a purification plant, a pumping station or internal pumps at the purification plant.

28. A pump management system for optimization of the energy consumption per quantum pumped fluid by operation of a fluid transporting pipe system comprising a number (n) of pumps to move the fluid through the pipe system, comprising:
means for measuring one or more parameters for a fluid transport through the pipe system from a starting point (A), from where the fluid is pumped, to an end point (B) whereto the fluid is pumped, which parameters alone or in combination represents at least one energy consumption per quantum pumped fluid and flow for the operation of each pump and the flow through the fluid transporting pipe system;
means for monitoring the parameters;
means for calculating, on the basis of the monitored parameters, actual system characteristics for the operation of each pump or combinations of pumps for the flow through the pipe system from the starting point A to the end point B, and for, on the basis of the established actual pump characteristics selecting the system characteristic and operation frequency at which one or more of the pump(s) alone, in turns or together must be activate in a period of time in order to achieve a given desired pumping speed through the pipe system or a given desired pumping volume with the least possible total energy consumption per quantum pumped fluid.

29. The pump management system according to claim 28, wherein the pump management system comprises at least one frequency converter for regulation of the operation frequency of the pumps in the fluid transporting pipe system.

30. The pump management system according to claim 28, wherein the fluid is chosen from the group consisting of crude water from a ground water well, water from reservoir to reservoir, clear water from a waterworks, or another natural reservoir, cleaned wastewater from or to a purification plant or pumping station or internal pumps at the purification plant.

31. The pump management system according to claim 28, wherein the means for calculating actual system characteristics comprises a software program.

32. A method for pumping water to or from a reservoir using the least possible energy consumption per quantum pumped fluid which comprises pumping the water through a fluid transporting pipe system comprising a number (n) of pumps to move the fluid through the pipe system according to the method of claim 16.

33. A pumping system for pumping water to or from a reservoir using the least possible energy consumption per quantum pumped fluid which comprises pumping the water through the pump management system according to claim 28.
